(19) United States
(12) Patent Application Publication
(10) Pub. No.: US 2004/0191393 A1
(43) Pub. Date: Sep. 30, 2004

(54) High fibre biscuit composition and a process for preparing the same

(76) Inventors: Madhugiri Lakshminarayan Sudha, Mysore (IN); Rathinam Vetrimani, Mysore (IN); Krishna Rau Leelavathi, Mysore (IN)

Correspondence Address: McDonnell Boehnen Hulbert & Berghoff, 32nd Floor, 300 S. Wacker Drive, Chicago, IL, 60606, US

(21) Appl. No.: 10/397,584

(22) Filed: Mar. 26, 2003

(51) Int. Cl. A23L 1/168

(52) U.S. Cl. 426/618

(57) ABSTRACT

The invention relates to a high fibre biscuit composition for increasing the dietary fibre content in the biscuit, said biscuit composition comprising 30 to 55% by wt. of wheat flour, 5 to 40% by wt. of a fibre source, 0.10 to 0.35% by wt. of emulsifiers and the rest being food grade additives, flavoring agents and preservatives and a process for preparing the high fibre biscuits.

### FIELD OF THE INVENTION

The present invention relates to a high fibre biscuit composition and a process for the preparing the same.

### BACKGROUND AND PRIOR ART REFERENCES OF THE INVENTION

Bakery industry is one of the biggest industries within the food processing sector and biscuit industry is the largest segment in bakery industry because of its nutrition profile, ready to eat product, rich in energy, excellent source of supplement diet, easy to digest and overall highly hygienic. Biscuit market is being shaped by nutritious and healthy biscuits which are either enriched with cereals and fibre. Today's consumers are increasingly concerned with their diet and people are looking for nutritious and healthy diet. Bakery products especially high fibre bakery products with increased levels of fibre have been prepared where in specific volume and softness is retained. (Silva R F, U.S. Pat. No. 5035903).

Fibres act as a barriers of diffusion of nutrients by producing viscous digesta in the small intestine, the more prolonged blood glucose response aids in maintaining a normal glucose level. The dietary fibre play a multiple role in preventing number of health disorders through their influence in the gastrointestinal tract (Potty, V. H. 1996 Physico chemical aspects, physiological functions, nutritional importance and technological significance of dietary fibres—A critical appraisal. Journal of food science and Technology. Vol. 33. pp 1-18).

The type of processing used to produce high fibre ingredients greatly influences the final ingredients functionality. The degree to which these are processed also effect the functionality. (Nelson, A. L. 2001. Properties of high fibre ingredients. Cereal Food world vol. 46(3), pp 93-97).

Non starch polysaccharides are the main constituents of cell wall which is referred to as dietary fibre. Dietary fibre functions as a protective factor against colon cancer. It also reduces the conversion of bile acids into potential carcinogens in the large intestine. (Pomeranz, Wheat chemistry and Technology. pp 99-101).

Reference may be made to C. G. Gorczyca and M. E Zabik 1979, Cereal chemistry, 56(6): 537-540, wherein high fibre sugar snap cookies containing cellulose and coated cellulose products were prepared. The draw back is 10% of flour substituted by the fibre had good quality product but it could approximately supplement 1.2 g of dietary fibre per 24 g of cookie.

Reference may be made to cappel James Wilbur, Prosise Robert Lawerence and Conrts Julia Maria, (EP 0387933) wherein cookies were prepared using psyllium fibre. The eating quality was good but still had slight tendency for the composition to stick to and/or form a film on teeth during chewing.

Reference may be made to Caramelli Gianfranco (WO 9007880) where in dietic food in the form of biscuits with high contents in alimentary fibre and reduced contents in calories were prepared. Where in gluocomannan (10-16%) and maize meal (5-25%) are used as good source of fibre and the biscuits are not short dough biscuits.

Reference may be made to Hudson Wilbur george, pflaumer phillip Floyd and smith III Edward Dwey (EP 0309029) wherein cookies were prepared using psyllium and a method for the preparation has been described. The cookies also contained polyol polyesters, a chemical which is used which might not be allowed in bakery products in several parts of the world, including India.

Reference may be made to Vaszily Josef (WO 9516355) where in sugar free confectionery products like fine bakery wares and kinds of biscuits were prepared. Where in studies are carried out to incorporate milk protein as a sugar replacer along with some sweeteners. The drawback is the composition which can be used for the preparation of high fibre/sugar free products contain artificial sweeteners which might not be allowed in bakery products in several parts of the world, including India.

### OBJECTS OF THE INVENTION

The main object of the present invention is to provide a high fibre biscuit composition and a process for the prepration of high fibre biscuits.

Another object of the present invention is to increase the dietary fibre content in the biscuits. Yet another object of the present invention is to replace flour by fibre from any cereal source of particular particle size.

Yet another object of the present invention is to use fibre from rice/wheat/oat/barley. A further object of the present invention is to replace flour with fibre, in combination, from different cereal sources keeping oat fibre as one of the components.

A still further object of the present invention is to use a combination of two emulsifiers to improve the overall quality and texture of the biscuits containing high fibre.

### SUMMARY OF THE INVENTION

Accordingly, the present invention provides a high fibre biscuit composition for increasing the dietary fibre content in the biscuit, said biscuit composition comprising 30 to 55% by wt. of wheat flour, 5 to 40% by wt. of a fibre source, 0.10 to 0.35% by wt. of emulsifiers and the rest being food grade additives, flavoring agents and preservatives and also a process for preparing the same.

### DETAILED DESCRIPTION OF THE PRESENT INVENTION

The present invention more particularly provides a high fibre biscuit composition, said biscuit composition comprising the following ingredients:

| Ingredients | Wt % |
|---|---|
| Refined wheat flour (70-72%) extraction | 30-55 |
| Fibre (−40 mesh sieve) | 5-40 |
| Sugar powder (+160μ sieve) | 10-25 |
| Fat (bakery, MP = 40° C.) | 8-15 |
| Skimmed milk powder (fat content < 1%) | 0.8-1.5 |
| Liquid glucose (food grade) | 0.8-1.5 |
| Glycerol mono stearate (food grade) | 0.05-0.20 |
| Lecithin (food grade) | 0.05-0.15 |
| Sodium chloride (food grade, no ionized) | 0.10-0.30 |
| Sodium bicarbonate (food grade) | 0.10-0.30 |
| Ammonium bicarbonate (food grade) | 0.5-1.0 |
| Flavouring agents (confirming to PFA) | 0.5-2.0 |

In an embodiment of the present invention, the fibre is a bran obtained from cereals and the cereals are selected from rice, wheat, oat, barley and mixtures thereof. In another embodiment, the emulsifiers are glycerol mono stearate and lecithin.

In a further embodiment, the food grade additives are fat, skimmed milk powder, liquid glucose and ammonium bicarbonate.

In a still further embodiment, the liquid glucose is dextrose and the fibre is a mixture of any brans of two cereals in the weight ratio of 10:1-1:10.

In yet another embodiment of the present invention, commercially available refined wheat flour was used and the wheat flour had the following characteristics: moisture 10-10.8% by weight, ash 0.4-0.5% by weight, dry gluten 8-9% by weight and protein 11-13% by weight.

In a still further embodiment of the present invention, refined wheat flour is sieved to remove impurities, provide aeration and homogenization.

In another embodiment of present invention, the fibre sources from different cereals had the following composition,

| Parameters (%) | Rice | Wheat | Barley | Oat |
|---|---|---|---|---|
| Moisture | 10.56 | 7.68 | 6.45 | 4.92 |
| Ash | 10.0 | 5.70 | 4.00 | 5.00 |
| Fat | 8.0 | 4.00 | 5.00 | 5.00 |
| Protein | 13.0 | 13.12 | 12.00 | 14.00 |
| Dietary fibre | 40.0 | 49.00 | 45.00 | 20.40 |

In yet another embodiment of the present invention, fibre from different sources like rice, wheat, barley and oat were ground and passed through 40 (425μ) mesh sieve. The throughs were collected for the preparation of biscuits.

In a further embodiment, the wheat flour, fibre and skimmed milk powder are passed through the sieve thrice.

In another embodiment, glycerol mono stearate is made into paste using 1-4% water by weight of flour.

In a further embodiment, the fat is bakery fat.

The present invention further relates to a process for the preparation of high fibre biscuits said process comprising the steps of (i) preparing a homogeneous blend of refined wheat flour, fibre source and skimmed milk powder; (ii) preparing a paste by mixing Glycerol mono stereate in the weight range of 0.1-0.4% by weight of flour, lecithin in the weight range of 0.1-0.4% by weight of flour with water, (iii) mixing the said paste with fat in the weight range of 17-25% by weight of flour, sugar powder in the weight range of 28-35% by weight of flour, liquid glucose, flavoring agent and creaming the paste for a time period in the range of 14-21 minutes to obtain a cream; (iv) preparing a solution of sodium chloride, ammonium bi-carbonate and sodium bi-carbonate in water and mixing the solution with the cream obtained in step (iii) and aging the cream for a time period of 10-15 minutes; (v) adding the homogeneous blend of flour obtained from step (i) to the cream obtained in step (iv) and mixing the same for 2-5 minutes to obtain a biscuit dough; and (vi) sheeting and moulding the biscuit dough of step (iv) and baking the same to obtain high fibre biscuit.

In yet another embodiment, the fat, sugar powder, liquid glucose, glycerol mono stearate,lecithin and flavoring agents are creamed in a horizontal or vertical mixer with a rpm of 60-180 for 14-21 minutes so as to mix uniformly all the ingredients and aerate the mixture.

In a still further embodiment, sodium chloride, sodium bicarbonate, ammonium bocarbonate are dissolved in the water and added to the cream and the said mixture is mixed for a period of 10-15 minutes using a horizontal or vertical mixer with an rpm of 60-180 into a uniform consistency homogeneous cream.

In yet another embodiment, wheat flour, fibre and skimmed milk powder blend is added to the cream and mixed for 2-5 minutes to form a homogeneous dough.

In another embodiment, sheeting and moulding of dough is done in a rotatory moulder using a circular die of about 4.5 cm diameter.

In a further embodiment, biscuits are baked in a continuous tunnel type oven at temperature ranging from 150-260° c. for 4-6 minutes of baking time and the baked biscuits are cooled at room temperature (25-30°) for a period of 30-45 minutes.

Following composition was used for the preparation of high fibre biscuits.

| Ingredients | Quantity (kg) |
|---|---|
| Refined wheat flour (70-72%) extraction | 60-90 |
| Fibre (−40 mesh sieve) | 40-10 |
| Sugar powder (+160μ sieve) | 28-35 |
| Fat (bakery, MP −40° C.) | 17-25 |
| Skimmed milk powder (fat content < 1%) | 1-4 |
| Liquid glucose (food grade) | 1-4 |
| Glycerol mono stearate (food grade) | 0.1-0.3 |
| Lecithin (food grade) | 0.1-0.3 |
| Sodium chloride (food grade, non ionized) | 0.2-0.6 |
| Sodium bicarbonate (food grade) | 0.2-0.6 |
| Ammonium bicarbonate (food grade) | 1.0-1.8 |
| Flavouring agents (confirming to PFA) | 1.0-4.0 |
| Total dry matter | 149.6-175.6 |
| Moisture in biscuits | 4.0-4.0 |
| | 153.6-179.6 |
| Production loss (0.5% kg) | 0.77-0.89 |
| Production loss due to aerating agents (0.75% kg) | 1.54-1.35 |
| Process deficit (0.5% kg) | 0.77-0.89 |
| | 3.08-3.13 |
| | 150.52-176.47 |

Yield of biscuits per 100 kg flour blend = 150.52-176.47 kg

The different unit operations and conditions involved in the preparation of high fibre biscuits using fibre from different cereals, emulsifiers like glycerol mono stearate and lecithin are given below in the flow chart.

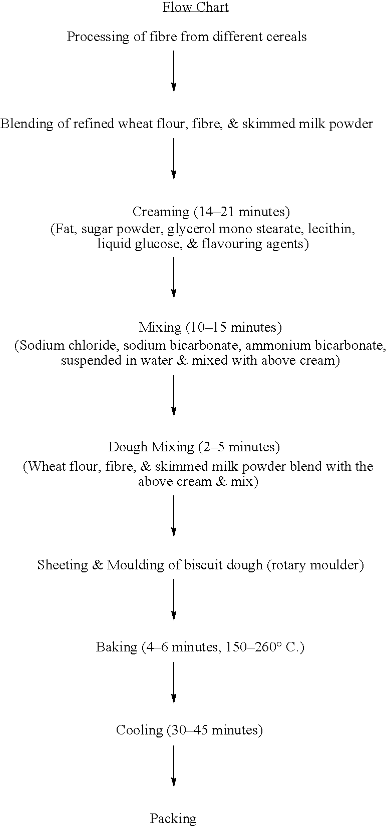

### EXAMPLE-1

In the present example biscuits were made using fibre passing through different mesh numbers namely 30 (600μ), 40(425μ), 60(250μ) to obtain medium fine, fine, and very fine particle size respectively. Ingredients along with quantities used in the present example are given below. Biscuits were prepared as given in the flow chart.

| | Quantity |
|---|---|
| Ingredients | (g) |
| Refined wheat flour (70-72% extraction) | 80.0 |
| Fibre (oat or barley or rice or wheat) | 20.0 |
| Fat (Bakery, 40° C. MP) | 20.0 |
| Sugar powder (+120μ sieve) | 30.0 |
| Skimmed milk powder (Fat content < 1%) | 2.0 |
| Dextrose (Food grade) | 2.0 |
| Sodium chloride (Food grade) | 1.0 |
| Sodium bicarbonate (Food grade) | 0.3 |
| Ammonium bicarbonate (Food grade) | 1.5 |
| Flavouring agent | 3.0 |
| Glycerol mono stearate (Food grade) | 0.3 |
| Lecithin (Food grade) | 0.2 |

Evaluation of biscuits

| | Weight | Width | Thickness | Spread ratio | Texture |
|---|---|---|---|---|---|
| Mesh no | (g) | (cm) | (cm) | (W/T) | (Kg, Force) |
| 30 | 8.20 | 5.40 | 0.69 | 7.83 | 1.78 |
| 40 | 8.10 | 5.56 | 0.65 | 8.55 | 1.80 |
| 60 | 8.10 | 5.65 | 0.64 | 8.83 | 2.05 |

Results of the experiment showed that by using fibre of medium fine size, biscuit dough was slightly crumbly. The dough made from fine fibre was cohesive and very good to handle. Where as the dough prepared from very fine fibre was had more cohesive due to more addition of water required for the dough preparation. Spread of the biscuits increased to 5.65 cm and the thickness of the biscuit decreased to 0.64 cm by the reduction in particle size. The biscuits became harder as shown by the objective measurement of the texture measured by texture analyser wherein the breaking strength values increased from 1.78 to 2.05 Kg as the particle size reduced. Subjective evaluation of biscuits showed that biscuits were little shrunken in case of those containing very fine particle size of fibre. Biscuits were crumbly, gritty and little powdery when medium coarse particle size of fibre was used.

### EXAMPLE-2

In the present example, biscuits were prepared with different fibre namely rice, wheat, oat and barley by replacing 20% of wheat flour. Ingredients and the quantities used in the following example are given below. Biscuits were prepared as in the flow chart.

| | Quantity |
|---|---|
| Ingredients | (g) |
| Refined wheat flour (70-72% extraction) | 80.0 |
| Fibre (Rice or wheat or oat or Barley) | 20.0 |
| Fat (Bakery, 40° C. MP) | 20.0 |
| Sugar powder (+120μ sieve) | 30.0 |
| Skimmed milk powder (Fat content < 1%) | 2.0 |
| Dextrose (Food grade) | 2.0 |
| Sodium chloride (Food grade) | 1.0 |
| Sodium bicarbonate (Food grade) | 0.3 |
| Ammonium bicarbonate (Food grade) | 1.5 |
| Flavouring agent | 3.0 |
| Glycerol mono stearate (Food grade) | 0.3 |
| Lecithin (Food grade) | 0.2 |

Evaluation of biscuits

| | Weight | Width | Thickness | Spread ratio | Texture |
|---|---|---|---|---|---|
| Bran | (g) | (cm) | (cm) | (w/T) | (Kg/Force) |
| Rice | 8.39 | 5.18 | 0.68 | 7.61 | 2.53 |
| Wheat | 8.16 | 5.42 | 0.68 | 7.97 | 1.97 |
| Oat | 8.39 | 5.56 | 0.68 | 8.17 | 1.67 |
| Barley | 7.87 | 5.33 | 0.66 | 8.07 | 1.88 |

Evaluation of the biscuits showed that the weight of biscuits containing oat and barley fibre were 8.39 and 7.87 g respectively. The width of the biscuits for rice and wheat fibre biscuits were 5.18 & 5.42 cm respectively, where as that for oat & barley biscuits was 5.56 and 5.33 cm respectively. The thickness of the biscuits ranged between 0.66 and 0.68 cm. The breaking strength of the biscuits as measured objectively was found to be lowest at 1.67 for oat, followed by 1.88 Kg for Barley fibre biscuits, 1.97 Kg for wheat fibre biscuits and 2.53 Kg for rice fibre biscuits respectively.

Subjective evaluation of biscuits showed that the biscuits prepared from rice fibre had dark brown crust colour among all the four types of biscuits. Oat and Barley fibre biscuits had good texture, mouthfeel, taste and overall quality when compared to rice & wheat fibre biscuits. Rice fibre & wheat fibre biscuits had slightly dense & compact crumb when compared to porous & open crumb for Oat and Barley biscuits. Biscuits containing rice fibre also had relatively harder texture.

### EXAMPLE-3

In the present example biscuits were prepared using different combination of fibre like oat & rice, oat & wheat, oat & barley fibre without changing the total percentage of fibre in the formulation. The two fibres were blended at 1:1 ratio. Ingredients and quantities used in the following example are given below and biscuits were prepared as given in the flow chart.

| Ingredients | Quantity (g) |
|---|---|
| Refined wheat flour (70-72% extraction) | 80.0 |
| Fibre (1:1) | 20.0 |
| Fat (Bakery, 40° C. MP) | 20.0 |
| Sugar powder (+120μ sieve) | 30.0 |
| Skimmed milk powder (Fat content <1%) | 2.0 |
| Dextrose (Food grade) | 2.0 |
| Sodium chloride (Food grade) | 1.0 |
| Sodium bicarbonate (Food grade) | 0.3 |
| Ammonium bicarbonate (Food grade) | 1.5 |
| Essence | 3.0 |
| Glycerol mono stearate (Food grade) | 0.3 |
| Lecithin (Food grade) | 0.2 |

Evaluation of biscuits

| | Weight | Width | Thickness | Spread ratio | Texture |
|---|---|---|---|---|---|
| Fibre | (g) | (cm) | (cm) | (W/T) | (Kg/force) |
| Oat + Rice | 8.35 | 5.29 | 0.67 | 7.89 | 2.10 |
| Oat + wheat | 8.20 | 5.50 | 0.66 | 8.33 | 1.97 |
| Oat + Barley | 8.10 | 5.56 | 0.65 | 8.55 | 1.80 |

Evaluation of biscuits showed that the biscuits containing Oat & Barley fibre had least weight i.e 8.10 g when compared to 8.2 & 8.35 g for Oat+Wheat & Oat+Rice fibre biscuits. The spread of the biscuits in case of Oat+Barley fibre was highest at 5.56 cm when compared to Oat+Wheat & Oat+Rice which was 5.50 cm & 5.29cm respectively. The thickness of the biscuits was 0.65cm for biscuits containing Oat+Barley. Objective evaluation of texture using texture analyser showed the minimum breaking strength value for Oat+Barley biscuits compared to others.

Subjective evaluation of the biscuits showed that Oat+Barley fibre biscuits had good mouthfeel, taste and overall quality when compared to other combination. Oat+Rice fibre biscuits was slightly hard and gritty. Further experiments were done on biscuits containing oat and barley fibre.

### EXAMPLE-4

In the present example, biscuits were prepared without the addition of GMS and lecithin in the formulation. Ingredients and the quantity used in the formulation are given below. Biscuits were prepared as given in the flow chart.

| | Quantity |
|---|---|
| Ingredients | (g) |
| Refined wheat flour (70-72% extraction) | 80.0 |
| Fibre (oat and barley) | 20.0 |
| Fat (Bakery, 40° C. MP) | 20.0 |
| Sugar powder (+120μ sieve) | 30.0 |
| Skimmed milk powder (Fat content < 1%) | 2.0 |
| Dextrose (Food grade) | 2.0 |
| Sodium chloride (Food grade) | 1.0 |
| Sodium bicarbonate (Food grade) | 0.3 |
| Ammonium bicarbonate (Food grade) | 1.5 |
| Flavouring agent | 3.0 |

Evaluation of biscuits

| | Weight | Width | Thickness | Spread ratio | Texture |
|---|---|---|---|---|---|
| | (g) | (cm) | (cm) | (w/T) | (Kg/force) |
| A | 8.13 | 5.20 | 0.54 | 8.60 | 2.02 |
| B | 8.10 | 5.56 | 0.65 | 8.55 | 1.80 |

A—Biscuits without GMS and lecithin, B—Experimental biscuits

Evaluation of biscuits showed that the width of the biscuit was 5.20 and the thickness was 0.54 cm. The spread ratio was 8.60. The breaking strength measured objectively was 2.02 Kg.

The subjective evaluation showed that the biscuits had compact and non-porous crumb structure. Biscuits were little shrunken and were relatively dense with slight sticky mouthfeel.

### EXAMPLE-5

In the present example biscuits were prepared without GMS in the formulation. Ingredients and quantity used in the following example are given below. Biscuits were prepared as in the flow chart.

| | Quantity |
|---|---|
| Ingredients | (g) |
| Refined wheat flour (70-72% extraction) | 80.0 |
| Fibre (oat + Barley) | 20.0 |
| Fat (Bakery, 40° C. MP) | 20.0 |
| Sugar powder (+120μ sieve) | 30.0 |
| Skimmed milk powder (Fat content < 1%) | 2.0 |
| Dextrose (Food grade) | 2.0 |
| Sodium chloride (Food grade) | 1.0 |
| Sodium bicarbonate (Food grade) | 0.3 |
| Ammonium bicarbonate (Food grade) | 1.5 |
| Flavouring agent | 3.0 |
| Lecithin (Food grade) | 0.5 |

Evaluation of biscuits

| | Weight | Width | Thickness | Spread ratio | Texture |
|---|---|---|---|---|---|
| | (g) | (cm) | (cm) | (W/T) | (Kg, Force) |
| A | 8.10 | 5.52 | 0.64 | 8.63 | 1.98 |
| B | 8.10 | 5.56 | 0.65 | 8.55 | 1.80 |

A - Biscuits without GMS
B - Experimental

Evaluation of biscuits showed that the width of the biscuit was 5.52 cm and the thickness was 0.64 cm. The spread ratio of the biscuit was 8.63. The weight of the biscuit was 8.1 whereas the breaking strength was 1.98 Kg.

Subjective evaluation showed that the biscuits had uniform colour, slightly dense and did not have porous crumb structure.

### EXAMPLE-6

In the present example, biscuits were prepared without lecithin in the formulation. The quantities of ingredients used in the following example are given below. Biscuits were prepared as in the flow chart.

| | Quantity |
|---|---|
| Ingredients | (g) |
| Refined wheat flour (70-72% extraction) | 80.0 |
| Fibre (oat + barley) | 20.0 |
| Fat (Bakery, 40° C. MP) | 20.0 |
| Sugar powder (+120μ sieve) | 30.0 |
| Skimmed milk powder (Fat content < 1%) | 2.0 |
| Dextrose (Food grade) | 2.0 |
| Sodium chloride (Food grade) | 1.0 |
| Sodium bicarbonate (Food grade) | 0.3 |
| Ammonium bicarbonate (Food grade) | 1.5 |
| Flavouring agent | 3.0 |
| Glycerol mono stearate (Food grade) | 0.5 |

Evaluation of biscuits

| | Weight | Width | Thickness | Spread ratio | Texture |
|---|---|---|---|---|---|
| | (g) | (cm) | (cm) | (w/T) | (Kg/force) |
| A | 8.10 | 5.55 | 0.63 | 8.80 | 1.95 |
| B | 8.10 | 5.56 | 0.64 | 8.55 | 1.80 |

A - Biscuits without lecithin,
B - Experimental Biscuits

Evaluation of biscuits showed that the width of the biscuits was 5.55 cm and the thickness of the biscuit was 0.63 cm. The spread ratio was 8.80. The weight of the biscuit was 8.10 g. The breaking strength of the biscuit was 1.95 Kg.

The results showed that biscuits containing a combination of both lecithin and GMS were crisper and hence were more acceptable than when GMS was used alone in the formulation.

High fibre biscuits thus prepared using fibre from different cereals in combination having high dietary fibre and using glycerol mono stearate & lecithin has the following advantages.

1. Processing of fibre & using fibre to a particular particle size imparts better crispness & wholesome mouthfeel to the biscuit quality.

2. Formulation of high fibre biscuits are rich in fibre content than the normal type of short dough biscuits. It can therefore be considered as a health snack food. Analysis of control (experimental) and high fibre biscuits have shown dietary fibre content in the range of 1.5-1.8% & 6.9-7.6% respectively

3. Using of oat and barley fibre in combination helps in incorporation of fibre which has more nutritive value when compared to wheat and rice fibre. The soluble dietary fibre content is very high in the sample than compared to either control or biscuits made from either wheat fibre or rice fibre.

| | Soluble dietary | Insoluble dietary | Total fibre |
|---|---|---|---|
| Biscuit sample | fibre (%) | fibre (%) | (%) |
| Control | 1.2 | 0.4 | 1.6 |
| High fibre biscuits | 2.5 | 5.1 | 7.6 |

4. High fibre biscuits contain a well-balanced combination of two emulsifiers namely glycerol mono stearate and lecithin. The combinations of these two emulsifiers in the right proportion provides a good aeration to the cream and thus make the product much crispier.

1. A high fibre biscuit composition for increasing the dietary fibre content in the biscuit, said biscuit composition comprising 30 to 55% by wt. of wheat flour, 5 to 40% by wt. of a fibre source, 0.10 to 0.35% by wt. of emulsifiers and the rest being food grade additives, flavoring agents and preservatives.

2. A high fibre biscuit composition as claimed in claim 1, wherein the fibre is bran obtained from cereals.

3. A high fibre biscuit composition as claimed in claim 2 wherein the cereals are selected from rice, wheat, oat, barley and mixtures thereof.

4. A high fibre biscuit composition as claimed in claim 1 wherein the emulsifiers are glycerol mono stearate and lecithin.

5. A high fibre biscuit composition as claimed in claim 1 wherein the food grade additives are fat, skimmed milk powder, liquid glucose and ammonium bicarbonate.

6. A high fibre biscuit composition as claimed in claim 5, wherein the liquid glucose is dextrose.

7. A high fibre biscuit composition as claimed in claim 3, wherein the fibre is a mixture of any brans of two cereals in the weight ratio of 10:1-1:10.

8. A high fibre biscuit composition, said biscuit composition comprising the following ingredients:

| Ingredients | Wt % |
|---|---|
| Refined wheat flour (70-72%) extraction | 30-55 |
| Fibre (−40 mesh sieve) | 5-40 |
| Sugar powder (+160μ sieve) | 10-25 |
| Fat (bakery, MP = 40° C.) | 8-15 |
| Skimmed milk powder (fat content < 1%) | 0.8-1.5 |
| Liquid glucose (food grade) | 0.8-1.5 |
| Glycerol mono stearate (food grade) | 0.05-0.20 |
| Lecithin (food grade) | 0.05-0.15 |
| Sodium chloride (food grade, no ionized) | 0.10-0.30 |
| Sodium bicarbonate (food grade) | 0.10-0.30 |
| Ammonium bicarbonate (food grade) | 0.5-1.0 |
| Flavouring agents (confirming to PFA) | 0.5-2.0 |

9. A high fibre biscuit composition as claimed in claim 8, wherein said composition comprises the following ingredients:

| Ingredients | Wt % |
|---|---|
| Refined wheat flour (70-72% extraction) | 49.91 |
| Fibre (oat or barley or rice or wheat) | 12.48 |
| Fat (Bakery, 40° C. MP) | 18.71 |
| Sugar powder (+120μ sieve) | 12.48 |
| Skimmed milk powder (Fat content < 1%) | 1.25 |
| Dextrose (Food grade) | 1.25 |
| Sodium chloride (Food grade) | 0.19 |
| Sodium bicarbonate (Food grade) | 0.12 |
| Ammonium bicarbonate (Food grade) | 0.62 |
| Flavouring agent | 1.9 |
| Glycerol mono stearate (Food grade) | 0.94 |
| Lecithin (Food grade) | 1.87 |

10. A high fibre biscuit composition as claimed in claim 8, wherein said composition comprises the following ingredients:

| Ingredients | Wt % |
|---|---|
| Refined wheat flour (70-72% extraction) | 49.91 |
| Fibre (1:1) | 12.48 |
| Fat (Bakery, 40° C. MP) | 18.71 |
| Sugar powder (+120μ sieve) | 12.48 |
| Skimmed milk powder (Fat content < 1%) | 1.25 |
| Dextrose (Food grade) | 1.25 |
| Sodium chloride (Food grade) | 0.19 |
| Sodium bicarbonate (Food grade) | 0.12 |
| Ammonium bicarbonate (Food grade) | 0.62 |
| Flavouring agent | 1.9 |
| Glycerol mono stearate (Food grade) | 0.94 |
| Lecithin (Food grade) | 1.87 |

11. A process for the preparation of high fibre biscuits, said process comprising the steps of:
(i) preparing a homogeneous blend of refined wheat flour, fibre source and skimmed milk powder;
(ii) preparing a paste by mixing glycerol mono stereate in the weight range of 0.1-0.4% by weight of flour, lecithin in the weight range of 0.1-0.4% by weight of flour with water,
(iii) mixing the said paste with fat in the weight range of 17-25% by weight of flour, sugar powder in the weight range of 28-35% by weight of flour, liquid glucose, flavouring agent and creaming the paste for a time period in the range of 14-21 minutes to obtain a cream;
(iv) preparing a solution of sodium chloride, ammonium bi-carbonate and sodium bi-carbonate in water and mixing the solution with the cream obtained in step (iii) and aging the cream for a time period of 10-15 minutes;
(v) adding the homogeneous blend of flour obtained from step (i) to the cream obtained in step (iv) and mixing the same for 2-5 minutes to obtain a biscuit dough; and
(vi) sheeting and moulding the biscuit dough of step (v) into shapes and baking the same to obtain high fibre biscuit.

12. A process as claimed in claim 11, wherein the fibre source is bran obtained from cereals.

13. A process as claimed in claim 12, wherein the cereals are selected from rice, wheat, oat, barley and mixtures thereof.

14. A process as claimed in claim 13, wherein the fibre source is a mixture of brans of any two cereals in the weight ratio of 10:1-1:10.

15. A process as claimed in claim 11 wherein in step (i), commercially available refined wheat flour is used.

16. A process as claimed in claim 15, wherein the refined wheat flour used has moisture content in the weight range of 10-10.8% by weight, ash in the weight range of 0.4-0.5% by weight, dry gluten in the weight range of 8-9% by weight and protein in the weight range of 11-13% by weight.

17. A process as claimed in claims 15, wherein the refined wheat flour is sieved to remove impurities.

18. A process as claimed in claims 15, wherein the refined wheat flour is aerated and homogenised.

19. A process as claimed in claim 11 wherein in step (i), wheat flour, fibre and skimmed milk powder are blended uniformly by passing through a sieve.

20. A process as claimed in claim 19, wherein the sieve has holes in a diameter range of 110μ-140μ.

21. A process as claimed in claim 19, wherein wheat flour, fibre and skimmed milk powder are passed through the sieve thrice.

22. A process as claimed in claim 11, wherein glycerol mono stearate is made into paste using 1-4% water by weight of flour.

23. A process as claimed in claim 11, wherein in step (iii), the fat is bakery fat.

24. A process as claimed in claim 11 wherein in step (iii), the fat, sugar powder, liquid glucose, glycerol mono stearate, lecithin and flavoring agents are creamed in a horizontal or vertical mixer with a rpm of 60-180 for 14-21 minutes so as to mix uniformly all the ingredients and aerate the mixture.

25. A process as claimed in claim 11, wherein sodium chloride, sodium bicarbonate, ammonium bicarbonate are dissolved in the water and added to the cream and the said mixture is mixed for a period of 10-15 minutes using a horizontal or vertical mixer with an rpm of 60-180 into a uniform consistency homogeneous cream.

26. A process as claimed in claim 11, wherein wheat flour, fibre and skimmed milk powder blend is added to the cream and mixed for 2-5 minutes to form a homogeneous dough.

27. A process as claimed in claim 11, wherein sheeting and moulding of dough is done in a rotatory moulder using a circular die of about 4.5 cm diameter.

28. A process as claimed in claim 11, wherein biscuits are baked in a continuous tunnel type oven at temperature ranging from 150-260° c. for 4-6 minutes of baking time and thereafter, cooled at room temperature (25-30°) for a period of 30-45 minutes.
